(19) United States
(12) Patent Application Publication
(10) Pub. No.: US 2007/0143759 A1
(43) Pub. Date: Jun. 21, 2007

(54) Scheduling and partitioning tasks via architecture-aware feedback information

(76) Inventors: Aysel Ozgur, Minneapolis, MN (US); Gregory T. Buehrer, Columbus, OH (US); Anthony D. Nguyen, Castro Valley, CA (US); Daehyun Kim, San Jose, CA (US); Victor W. Lee, San Jose, CA (US); Mikhail Smelyanskiy, Mountain View, CA (US); Yen-Kuang Chen, Cupertino, CA (US)

Correspondence Address: TROP PRUNER & HU, PC, 1616 S. VOSS ROAD, SUITE 750, HOUSTON, TX, 77057-2631, US

(21) Appl. No.: 11/300,809

(22) Filed: Dec. 15, 2005

(51) Int. Cl. G06F 9/46

(52) U.S. Cl. 718/102

(57) ABSTRACT

In one embodiment, the present invention includes a method for performing a first level task of an application in a first processor of a system and dynamically allocating a second level task of the application to one of the first processor and a second processor based on architectural feedback information. In this manner, improved scheduling and application performance can be achieved by better utilizing system resources. Other embodiments are described and claimed.

### BACKGROUND

Embodiments of the present invention relate to data processing and more particularly to performing scheduling of activities across multiple processors using architecture-aware feedback information.

The ability to process great amounts of data is becoming easier due to improved and greater processing resources. For example, many multiprocessor-type systems exist that can be used to implement complex algorithms to process great amounts of data. However, the complex nature of such architectures and the algorithms used for such data processing can lead to complexities and inefficiencies. For example, due to the nature of an algorithm's workload one or more processors of a system with multiple processors can have significantly varying loads. Such variances in workloads can lead to deleterious effects, including the presence of idle processors while other processors are overloaded.

Furthermore, tasks partitioned to the various processor resources may not efficiently use data associated therewith. Accordingly, inefficiencies in obtaining data from slower portions of a memory hierarchy can affect performance. Still further, the need for such data can require significant inter-processor communications, which increase data traffic and slow performance of useful work. Still further, some algorithms require various levels of tasks. As a result, synchronizations may be required at each level of the algorithm, which forces all processors to synchronize at these locations, which can be consuming events.

Different manners of attempting to resolve such issues exist. For example, multiple tasks may be attempted to be load balanced across the number of processors available in a given system. Typically, such load balancing is a static-based balancing performed at initiation of an algorithm. Accordingly, load imbalances can still occur during runtime.

Common algorithms that are suitable for execution on a multiprocessor system are algorithms that maybe parallelized to take advantage of the architecture. One type of application that is suitable for multiprocessor implementation is a pattern mining application, for example, frequent pattern mining may be used to find recurring patterns in data. Different types of pattern mining including itemset mining, sequence mining and graph mining. Generally a pattern mining algorithm is implemented to find all patterns satisfying user-specified constraints in a given data set. If the pattern exists in at least a minimum number of entries (e.g., corresponding to a minimum threshold), the pattern is considered frequent, and may be grown by one item. The same mining procedure is recursively applied to a subset of the data set, which contains the so-far-mined pattern. However, pattern mining applications as well as many other such applications can suffer from inefficient use of resources in a multiprocessor system.

In a graph mining application, interesting patterns are found in graph-based databases. The most efficient frequent pattern mining implementations use depth first traversals. In performing these traversals, it is possible to maintain key data elements through recursive calls. The extra state improves serial execution performance at the cost of increased memory usage. For example, while a parent scans a database, it keeps a list of possible ways/places to grow the graph. If this list is kept, then its children can further grow the graph with less effort. The extra state may be maintained in different ways, for example, as embedding lists or global candidate lists. Embedding lists are the mappings of the currently-growing graph to its positions in the database. Thus a child does not need to find the mappings again to grow the graph further. A global candidate list is a list of all the ways to grow the current graph. By keeping this information, the child does not need to walk the graphs to find all ways to grow the graphs, it just adds to the list when it adds a new node. Maintaining such state may hinder scalability if the algorithm is parallelized for a many-core architecture.

Certain graph mining algorithms create and maintain state across parent and children graphs, while others do not. Algorithms that maintain the state have the lowest execution time for a small number of processors because the parent state is reused in child subgraphs. However, such algorithms do not scale well because of increased memory usage and communication. In contrast, algorithms that do not reuse the state do not run as fast for a small number of processors because they have to recompute state across tasks because the algorithm does not maintain state.

Another area suitable for multiprocessor execution is algorithms for computational finance. The rapid increase in computational power coupled with the application of increasingly sophisticated mathematical and statistical methods have given rise to the discipline of computational finance. Portfolio optimization and option pricing are two areas of computational finance.

Although the algorithms of portfolio optimization and option pricing are very different from each other and from frequent pattern mining, the parallelization method is similar. The general principle used in parallelization is as follows: i) partition the total work into independent tasks; ii) additional tasks can be generated by exploring multiple levels of parallelism; and iii) independent tasks (whether of the same level or of different levels) can be performed simultaneously.

### BRIEF DESCRIPTION OF THE DRAWINGS

FIG. 1 is a flow diagram of a method in accordance with one embodiment of the present invention.

FIG. 2 is a diagram of a tree structure of a frequent sequence mining algorithm as executed on a multiprocessor system in accordance with one embodiment of the present invention.

FIG. 3 is a diagram of a tree structure for the same frequent sequence mining algorithm of FIG. 2 in accordance with another embodiment of the present invention.

FIG. 4 is a flow diagram of a method in accordance with another embodiment of the present invention.

FIG. 5 is a block diagram of a dynamic task partitioning and allocation scheduling system in accordance with one embodiment of the present invention.

FIG. 6 is a flow diagram of a method for determining whether to save state in accordance with an embodiment of the present invention.

FIG. 7 is a diagram of a search space for a depth first graph mining algorithm in accordance with one embodiment of the present invention.

FIG. 8 is a diagram of an elimination tree in accordance with one embodiment of the present invention.

FIG. 9 is a diagram of tile partitioning in accordance with an embodiment of the present invention.

FIG. 10 is a block diagram of a system in accordance with an embodiment of the present invention.

### DETAILED DESCRIPTION

To provide effective use of multiprocessor resources, an algorithm may be parallelized for execution across a system, e.g., a multiprocessor system. The parallelization may take into account load balancing, data or cache localities, and minimal communication overhead between various processors of the system. In this way, an efficient scheme for using processing resources in a multiprocessor system may be provided. In some embodiments, a dynamic task partitioning scheme further may be implemented to effect load balancing. More particularly, a processing load may be shared by dynamically partitioning tasks into smaller tasks or subtasks based on the availability of additional processing resources. Furthermore, various embodiments may implement a cache-conscious task scheduling scheme. That is, the scheduling scheme may seek to reuse data of a given task over multiple tasks in related processing resources. While seeking to reuse data as much as possible between tasks, communication overhead between processors may also be minimized by choosing to repeat certain amounts of computation in exchange for reducing communication overhead.

In various embodiments, task partitioning and scheduling may be implemented based on various feedback information available in a system. Such information may include architectural feedback information such as information regarding processor utilization, environmental parameters and the like. The feedback information may further include information from a running application. More specifically, an application may use its knowledge of its own operation and its use of data to provide application (e.g., user-level) information regarding data locality. Based on the various feedback information received, a task scheduler may choose to partition pending tasks into additional tasks and further to control what processing resources are to perform the tasks based on the architectural feedback information and the data locality feedback information, for example.

Certain embodiments discussed herein are with respect to specific algorithms for frequent sequence mining and more particularly to recursive-based algorithms. However, it is to be understood that the scope of the present invention is not so limited, and in other embodiments task partitioning and scheduling as described herein may be effected in other applications.

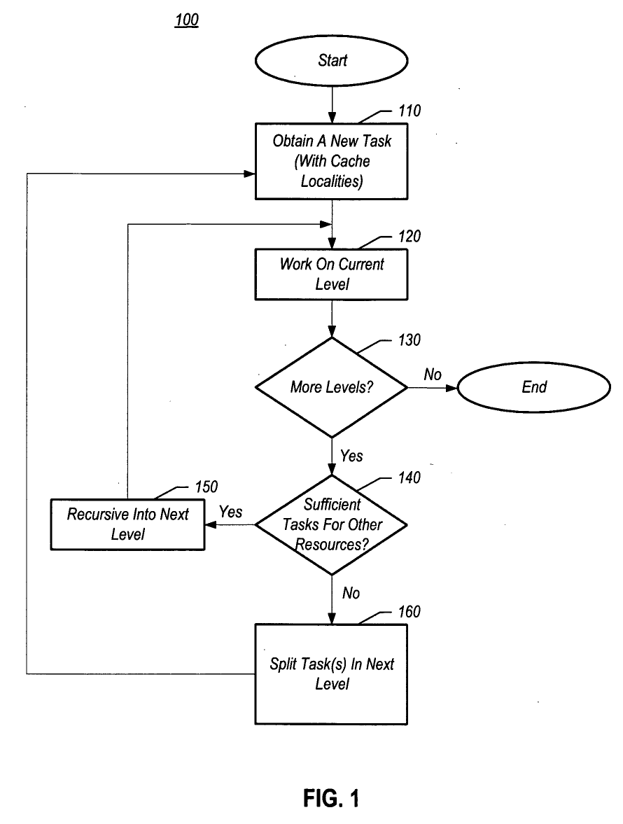

Referring now to FIG. 1, shown is a flow diagram of a method in accordance with one embodiment of the present invention. As shown in FIG. 1, method 100 may be used to perform dynamic task partitioning in accordance with an embodiment of the present invention. Method 100 may begin by obtaining a new task (block 110). In various embodiments, new tasks may be obtained in block 110 in various manners. In many implementations, architecturally-aware feedback information may be used in scheduling a new task to a processor. In this way, improved load balancing, data localities and minimal communication overheads may be realized. For example, a frequent sequence mining application may include multiple tasks to be performed. To obtain the task in a processor, a scheduler may provide the task for execution on the processor based on feedback information. This feedback information may include cache-conscious information such that the new task to be performed by a processor may take advantage of cache localities, e.g., by using data that is closely associated with the processor. For example, data to be used in the task may be present in a private cache of the processor or in a shared cache associated with the processor.

Based on scheduling of the new task to a processor or multiple processors, the processor(s) may work on the current level (block 120). Next, it may be determined whether additional levels are present in the algorithm (diamond 130). If not, method 100 completes. If instead at diamond 130 it is determined that additional levels are present, control passes to diamond 140. There, it may be determined whether there are sufficient tasks for other resources (diamond 140). For example, in one embodiment the determination may be based on certain architectural feedback information that one or more processors are idle or are about to become idle, or one or more processors are not being fully utilized. While described herein as being on a per-processor basis, it is to be understood that the determination of resource availability may be on different levels of granularity, such as a per-thread basis, per-core basis, per-block basis, per-processor basis or other such granularities as desired in a particular implementation. Furthermore, different embodiments may have different thresholds or other criteria in determining whether sufficient tasks exist for a given system environment. For example, in some implementations a task scheduler may choose to partition tasks when there are fewer pending tasks than available processors, while in other implementations a scheduler may choose to split tasks when there are fewer tasks than total processors present in the system. Other variations of course are possible. Furthermore, the criteria may be based on processor utilization as opposed to strictly on idleness basis. For example, a given processor may report a relatively low utilization rate, indicating it has further processing resource availability. Such a less than fully-utilized processor may receive additional tasks or subtasks, in some embodiments.

Still referring to FIG. 1, if it is determined that sufficient tasks are present, the algorithm may continue into the next level on its currently running processor(s). That is, the algorithm is recursive into its next level (block 150), without generating any more tasks. Accordingly, control passes back to block 120 discussed above.

If however at diamond 140 it is determined that insufficient tasks are available, control passes to block 160. There, one or more tasks may be split into multiple tasks, and one or more of these new tasks may be scheduled on different processors. Accordingly, control passes back to block 110, discussed above. While described in FIG. 1 with this particular implementation, it is to be understood the scope of the present invention is not so limited and task partitioning may be performed differently in other embodiments.

Using a method in accordance with an embodiment of the present invention optimal load balancing may be realized. In a frequent pattern mining algorithm, for example, tasks may be partitioned dynamically at each level of recursion. Furthermore, runtime architecture feedback such as processor utilization, cache usage, network congestion, and the like may be used for load balancing. In the embodiment of FIG. 1, tasks may be partitioned at each level of recursion based on this runtime feedback.

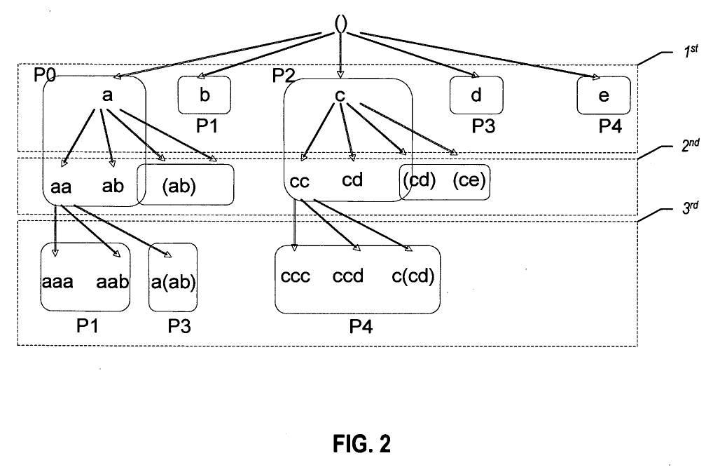

As discussed above, embodiments may be used in connection with frequent sequence mining or frequent pattern matching. Referring now to FIG. 2, shown is a block diagram of a tree structure of a frequent sequence mining algorithm as executed on a multiprocessor system. As shown in FIG. 2, different tasks of a frequent sequence mining algorithm (as shown in the solid boxes of FIG. 2) are assigned to different processors of the system. Specifically, as shown in FIG. 2, each processor is closely associated with given task(s) (i.e., a solid box) to indicate that the corresponding task is performed on the indicated processor. For example as shown in FIG. 2 at a first level various single item tasks (e.g., tasks a-e) are assigned to respective processors (e.g., processors P0-P4). Additional levels of the frequent sequence mining algorithm are shown in FIG. 2, namely a second level and a third level. More specifically, in the second level, tasks include ‘aa’, ‘ab’, ‘(ab)’, ‘cc’, ‘cd’, ‘(cd)’, and ‘(ce)’. In the third level, tasks include ‘aaa’, ‘aab’, ‘a(ab)’, ‘ccc’, ‘ccd’, and ‘c(cd)’. At each item of each level of the algorithm (i.e., at each task of each level), a determination may be made whether the task should be partitioned into one or more additional tasks for possible execution on other processors of the system. In one embodiment, this task partitioning may be performed in accordance with the flow diagram of FIG. 1, discussed above.

Still with reference to FIG. 2, an example of task partitioning is described with reference to the second level. Consider item ‘aa’ (i.e., at the second level of item ‘a’ in FIG. 2), and further assume there are two idle processors (e.g., P1 and P3) available, two new tasks may be created (i.e., item ‘aa’ is partitioned into {‘aaa’, ‘aab’ } and {‘a(ab)}) and assigned to P1 and P3, respectively. Further assume that at item ‘cc’ (i.e., at the second level of item ‘c’), there is only one idle processor (e.g., P4) available, a new task may be created and thus the third level of item ‘c’ may be assigned to P4.

In some implementations, if all the processors are busy, a scheduler may choose to partition tasks based on a minimum threshold of available tasks, which can be a system parameter. While described with this particular partitioning of tasks and their assignment to particular processors in the embodiment of FIG. 2, it is to be understood the scope of the present invention is not limited in this regard.

Referring now to Table 1 below, shown is a parallel frequent sequence mining algorithm (i.e., PrefixSpan) to effect architecture-aware dynamic task partitioning. The general outline of this algorithm is as follows. Given a pattern that is initially known, and a data set (S), all occurrences of patterns in the data set may be identified. Further, infrequent items may be removed from the data set. Then, if a pattern exists in at least a minimum threshold of entries, the pattern is grown by one item and the search for new patterns in the data set is performed recursively. Note that in recursively performing the algorithm, a current task may either continue on a current processor, or one or more new tasks may be created for other processors based on architecture feedback information. More specifically, as shown in Table 1 when calling the recursion for p′ and S′, a decision is made whether the task will keep executing the recursion on the same processor, or whether to create a new task to be executed on other processors. As discussed above, various architectural feedback can be used for this decision.

TABLE 1
Call PrefixSpan(null, S);
PrefixSpan (prefix p, dataset S)

Find all frequent items in S
Remove infrequent items from S
For each frequent item f

Append f to p to make p′=p|f
Project S to p′ to construct S′
Based on architecture feedback,
Keep executing PrefixSpan (p′, S′) on the current processor
Or
Create a new task for PrefixSpan (p′,S′) for other processors

End

End

In addition to task partitioning in accordance with an embodiment of the present invention, task scheduling may also be performed to improve cache usage. That is, pending tasks waiting to be executed may be stored in a task queue. Typically, tasks may be selected from the queue and performed in a predetermined order (e.g., first-in first-out (FIFO), last-in first-out (LIFO) or even random task scheduling). However, none of these methods take into consideration location of the data to be used in a given task. By using information obtained, e.g., from the application itself (i.e., a user-level application), dynamic task scheduling may be implemented in a cache-conscious manner that improves data usage, improves efficiency and reduces communication overhead. Different manners of implementing cache-conscious task scheduling may be performed. In some embodiments data locality information obtained from the application itself may be used in determining an appropriate processor to perform a particular task.

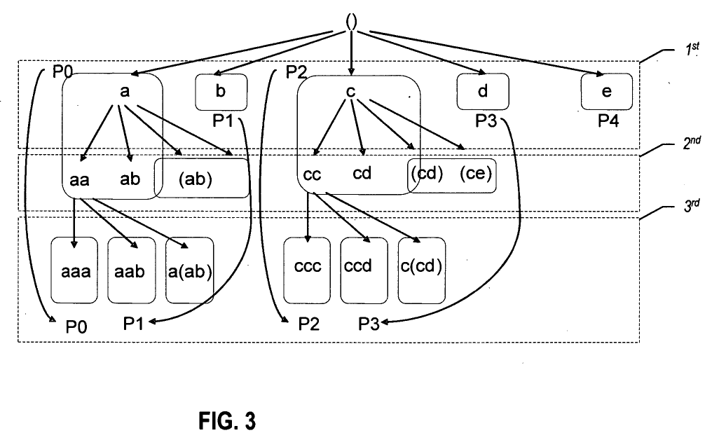

Referring now to FIG. 3, shown is a tree structure for the same frequent sequence mining algorithm as described with regard to FIG. 2. However, note that the processors performing the various tasks within the algorithm are different than in FIG. 2. As will be discussed, the processors shown in FIG. 3 may be selected to improve data locality and thus speed execution and reduce communication overheads.

Initially in the first level, as shown in FIG. 3, all processors are busy. When processor P2 (for example) finishes its tasks for the first and second-level items of ‘c’, all third-level tasks from ‘aaa’ to ‘c(cd)’ (i.e., the six tasks shown in level 3 of FIG. 3) are available. Thus one or more tasks may be scheduled to P2. Using embodiments of the present invention, cache-conscious task scheduling may be implemented to select one or more tasks to be next performed by processor P2. In this manner, data sharing that may exist in a given algorithm from parent task to child task may be accommodated. With reference to processor P2, because P2 has just finished second-level items of ‘c’, its cache already contains a data structure for item ‘cc’. Thus task ‘ccc’ may be assigned to P2 to exploit data reuse from item ‘cc’ to item ‘ccc’. Later when processor P0 finishes its task for item ‘a’, task ‘aaa’ may be assigned to P0 based on the same strategy.

Note that cache-conscious scheduling may take into consideration different levels of a memory hierarchy in certain embodiments. In this way, although a private cache of a given processor may not include data needed for a next task, a shared cache between, e.g., multiple cores of a chip multiprocessor (CMP) may contain the data, reducing the need for additional memory latencies and communication with a remainder of a memory hierarchy to obtain such data. Note that with respect to processors P1 and P3, when they complete their first level tasks (i.e., for items ‘b’ and ‘d’), assume that only tasks from items ‘a’ and ‘c’ are available for execution. Accordingly, these processors P1 and P3 do not include in their private cache data from item ‘a’ and item ‘c’.

However if P0 and P1 are two cores of a CMP system that share a middle-level cache (as are P2 and P3), task ‘aab’ may be assigned to P1, and task ‘ccd’ may be assigned to P3. In this way, reduced communication and latencies may be effected. That is, to obtain the needed data for performing the third-level tasks of item ‘a’ and item ‘c’ on either of processors P1 or P3, snoop traffic and/or memory requests need only extend to the middle-level cache to obtain the needed data. In contrast, if tasks were randomly assigned, the needed data may not be available without further communications and latencies to obtain the data from further distant portions of a memory hierarchy. Thus, a cache-conscious task scheduling algorithm in accordance with an embodiment of the present invention may improve performance by understanding the data sharing pattern of an algorithm and the cache architecture of a system, and applying the knowledge to task scheduling. Furthermore, feedback information from the application itself may be used to determine the data that is needed and further where that data has been recently used.

While different manners of implementing cache-conscious task scheduling may be performed, in some embodiments a data distance measure may be used. For example, each task that is to be performed may have a data usage identifier (ID) associated therewith. In one embodiment, a data usage ID for a given task may be a 3-tuple (i.e., address of the beginning of the accessed region, address of the end of the accessed region, and access pattern stride). Then the small Euclidean distance between two such data usage ID's will imply access to the same region. Of course, the distance calculation function may account for the fact that the region accessed by a first task is a sub-region of the region accessed by a second task. Each entry in a task queue may include the data usage ID along with a task identifier. Furthermore, a scheduler in accordance with an embodiment of the present invention may maintain a history of recent data usage IDs handled by each processor of the system. Accordingly, when a given processor has available resources, the scheduler may determine a data sharing distance measure based on a distance between the data usage IDs associated with the processor and the data usage IDs stored in the task queue. In this way, the task associated with the shortest distance may be assigned to that processor.

For example, if a processor becomes idle, a combination of data sharing distances between the data usage IDs of the processor's history and those of all available tasks may be calculated. The task with the shortest distance may be the task chosen for scheduling on the processor. Of course other manners of using data locality information may be effected in other embodiments.

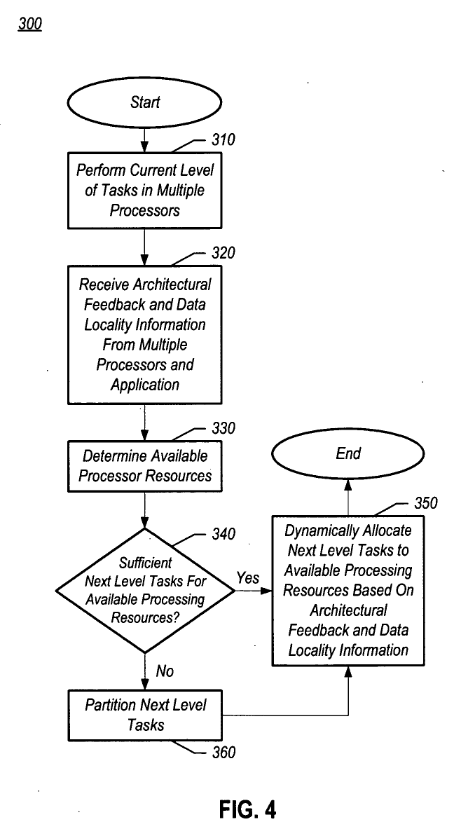

Referring now to FIG. 4, shown is a flow diagram of a method in accordance with another embodiment of the present invention. The method of FIG. 4 may be used to perform dynamic task partitioning and scheduling based on architectural feedback information. As shown in FIG. 4, method 300 may begin by performing a current level of tasks in multiple processors (block 310). For example, multiple processors of a multiprocessor system may each be performing tasks, e.g., of a first level of a frequent sequence mining or other desired application. In different implementations, the multiple processors may be individual cores of a multicore processor or one or more cores of each of multiple processors of a multiprocessor system.

Still referring to FIG. 4, next architectural feedback information and data locality information may be received, e.g., by a scheduler in accordance with an embodiment of the present invention (block 320). More specifically, a scheduler may receive architectural feedback information from the various processors or resources thereof. Furthermore, the application itself may provide feedback information, particularly data locality information. Note that in some embodiments the architectural feedback information may include information regarding the availability of resources, e.g., processors or portions thereof, utilization rates or the like. Furthermore, the architectural feedback information may include various operational parameters such as temperature, operating frequency, or other such information. In different embodiments, the data locality information may be obtained from the application itself and may be based on the application's own knowledge of the current location of data being used by different resources, as well as the data that is to be needed by additional levels of tasks.

Next, available processor resources may be determined (block 330). For example, a resource allocator may determine the availability of one or more processors or resources thereof based on the architectural feedback information. For example, if one or more processors are indicated to soon become available, such processors may be listed in a resource utilization queue, for example. Furthermore, depending on utilization rates of one or more processors, an underutilized processor or resources thereof may also be listed in the resource utilization queue.

Next, it may be determined whether sufficient next level tasks are available for the available processing resources (diamond 340). For example, a task partitioner may analyze the pending tasks, e.g., pending tasks in a task queue and compare it to the number of available resources. If sufficient tasks are available, control may pass to block 350. Note that the determination of sufficient tasks may be based on different criteria in different embodiments. For example, threshold-based criteria may be used in some embodiments. At block 350, if sufficient next level tasks exist, a resource scheduler may dynamically allocate next level tasks to the available processing resources based on the feedback information (block 350). For example, the resource scheduler may select a task to execute from the task queue on a given processor or resource thereof based on the feedback information, including data locality information. In this way, data that is present in a cache of a processor can be efficiently used or reused during execution of the next task without the need for obtaining the data from a memory hierarchy, improving latency and reducing communication overhead.

Still referring to FIG. 4, if instead at diamond 340 it is determined that insufficient tasks are available, control may pass to block 360. There, a task partitioner may partition one or more tasks of the next level into multiple tasks (block 360). These multiple tasks may then be placed into the task queue so that they may be scheduled on different processor resources to more efficiently perform the tasks. Accordingly, control may pass from block 360 to block 350, discussed above, where the tasks may be dynamically allocated to the available processing resources. While described with these particular operations in the embodiment of FIG. 4, it is to be understood that the scope of the present invention is not so limited and dynamic task partitioning and task scheduling may be performed in another manner.

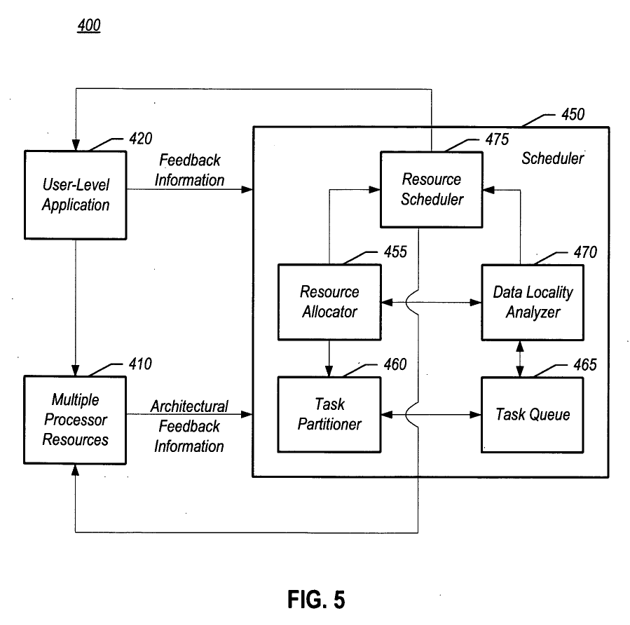

Referring now to FIG. 5, shown is a block diagram of a dynamic task partitioning and allocation scheduling system in accordance with one embodiment of the present invention. As shown in FIG. 5, system 400 includes multiple processor resources 410. As discussed above, these processor resources may be multiple cores of a single processor and/or may be multiple processors, in different embodiments. A user-level application 420 executes on these processor resources. Different user-level applications may be accommodated in different embodiments.

As further shown in FIG. 5, a scheduler 450 may be used to dynamically partition and schedule tasks across these multiple processor resources based on various feedback information. Specifically, as shown in FIG. 5, scheduler 450 receives feedback information from both processor resources 410 and user-level application 420. In one embodiment, scheduler 450 may receive architectural feedback information from multiple processor resources 410 and scheduler 450 may receive data locality feedback information from user-level application 420. Note that while scheduler 450 is shown as a separate block in FIG. 5, it is to be understood that, while logically separate from processor resources 410, scheduler 450 may be physically part of the processor resources themselves such as a front end block of one or more of the processors.

In addition, scheduler 450 may further be configured to determine whether to maintain state information of a given processor when executing a new task thereon. For example, as will be described further below, when a processor is to begin executing a subtask of a previously performed task on the processor, scheduler 450 may choose to maintain the state to improve performance and cache localities. In contrast, if a subtask of a previously executed task is to be performed on a different processor, the state is not communicated to the new processor, thus reducing memory footprint and communication overhead.

Still referring to FIG. 5, scheduler 450 may include a resource allocator 455, a task partitioner 460, a task queue 465, a data locality analyzer 470 and a resource scheduler 475. In various embodiments, resource allocator 455 may receive feedback information from multiple processor resources 410 and determine availability of resources within the multiple processors. While this feedback information may take many forms, in some embodiments the resource availability may provide an indication of processor identification and an available resource or resources therein.

This available resource information may be provided to task partitioner 460 and data locality analyzer 470. Task partitioner 460 may further receive feedback information from user-level application 420, e.g., data locality information, along with an indication of pending tasks in task queue 465. Based on the available resources as indicated by resource allocator 455 and the pending tasks in task queue 465, task partitioner 460 may choose to dynamically partition one or more of the tasks, e.g., of a next level of an application into multiple tasks. Accordingly, task partitioner 460 may provide the partitioned tasks to task queue 465. Task queue 465 may thus include entries for each pending task. In some implementations, in addition to the identification of pending tasks, each entry in task queue 465 may further include data locality information to indicate the location of data needed by the task.

In some embodiments, data locality analyzer 470 may receive pending entries from task queue 465, along with the identification of available resources, e.g., from resource allocator 455. Based on this information, data locality analyzer 470 may determine distances between data needed by the various tasks and the available resources. These data distances may be provided to resource scheduler 475. In various embodiments, resource scheduler 475 may select a task for execution on a particular processor (or resource thereof) based on the smallest data distance for a given processor or resource for the various tasks pending in task queue 465. Accordingly, resource scheduler 475 may provide control information to the selected processor or resource of multiple processor resources 410 and user-level application 420 to cause the selected pending task to be executed on the selected available resource. While described with this particular implementation in the embodiment of FIG. 5, it is to be understood that the scope of the present invention is not so limited.

By dynamically determining when to maintain state of a mining operation, temporal locality of a cache may be increased, without degradation in load balancing, memory usage, and task dependency. Accordingly, in certain embodiments the state of a parent task may be dynamically maintained to speed up a given algorithm (such as graph mining) when its descendant tasks are processed on the same processor. A parent task may generate a significant amount of state that may be shared in descendant tasks. For example, such state may take the form of an embedded list or a global candidate list.

When these descendant tasks run on the same processor, much of the state may still be in the processor's local cache, thus improving cache locality and reducing execution time. However, maintaining state may be too prohibitive if the memory footprint is large or may require too much communication if descendant tasks are assigned to different processors. This scheme thus may automatically eliminate state to maintain optimal footprint size or reduce communication when descendant tasks are assigned to different processors. Essentially, it is a dynamically hybrid scheme that either maintains state or does not reuse state, depending on where a task is to be performed. Table 2 is pseudocode of a depth-first algorithm that uses an embodiment of the present invention to mine frequent graphs.

TABLE 2
MineIt(Graph g, child c, embeddinglist el)

| | |
|---|---|
| 1. | newGraph = Add(g, c) |
| 2. | add newGraph to resultSet |
| 3. | if(el is not null) |

| | |
|---|---|
| 4. | Children C = FindAllChildren(newGraph,el) |

| | |
|---|---|
| 5. | else |

| | |
|---|---|
| 6. | Children C = FindAllChildrenAndBuildList(newGraph,el) |

| | |
|---|---|
| 7. | for each child c in C |

| | |
|---|---|
| 8. | if (c is frequent) |

| | | |
|---|---|---|
| 9. | if(queue needs work) | // hardware feedback |

| | | |
|---|---|---|
| 10. | Queue(newGraph, c) | // mine with null el |

| | |
|---|---|
| 11. | else MineIt(newGraph, c, el) // mine with parent state |

As shown in Table 2, this algorithm traverses the search space in depth first order, dynamically maintaining state (i.e., embeddinglist el) for descendent graphs. Portions of the subtask that will run on the same processor make use of the state of the parent (line 11). If instead the task is partitioned and assigned to another processor (line 10), the parent state is stripped out to minimize communication and/or memory footprint. This maintains a high level of temporal locality in the cache (when state is maintained), while still allowing the work to be partitioned at each recursion level (when state is removed). Thus, the algorithm balances concurrency with cache reuse. In addition, dynamic state maintenance facilitates mining much larger datasets because the system can adapt to the footprint of the workload. For this case, parent state is not preserved for descendant tasks. These decisions may be made at runtime based on feedback from hardware or runtime of the system. The runtime/hardware information such as memory utilization, processor affinity, neighbor processors, and communication latency may be used to determine whether state should be maintained across parent and descendant tasks. The end result is decreased execution times due to increased cache locality.

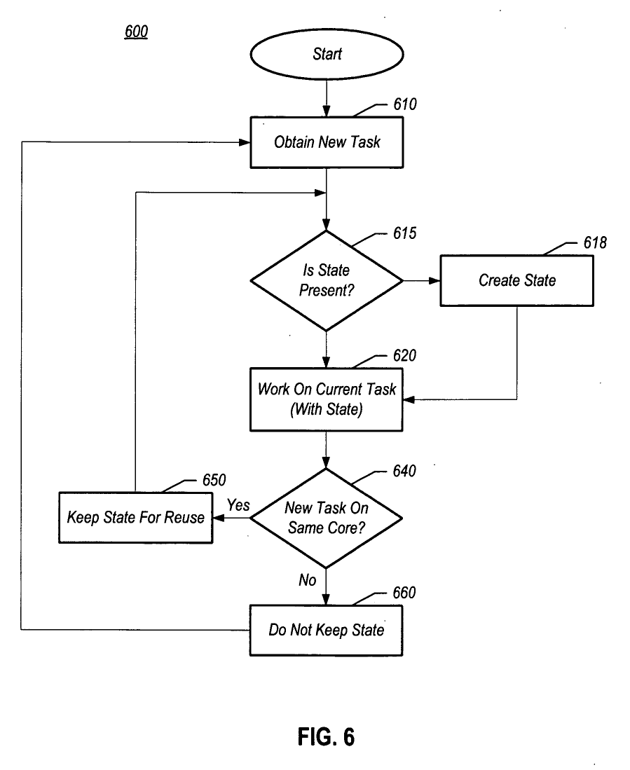

Referring now to FIG. 6, shown is a flow diagram of a method for determining whether to save state in accordance with an embodiment of the present invention. As shown in FIG. 6, method 600 may begin by obtaining a new task (block 610). For example, a graph mining algorithm may include multiple tasks to be performed. Next, it may be determined whether the state associated with the task is present in the processor that is to perform the task (diamond 615). If not, the state is created (block 618). For example, the state may be created from scratch, e.g., via scanning through a database and finding: 1) the currently growing graph to its positions in the database; and 2) a list of ways to grow the current graph.

Control passes, either from diamond 615 or block 618 to block 620. There, the current task may be processed using the state information either present in the processor or created in the processor (block 620). Upon completion of the current task, control passes to diamond 640. There it may be determined whether the next task is to be performed on the same processor, e.g., the same processor core (diamond 640). If so, the current state may be kept for reuse in connection with the new task (block 650). Accordingly, control passes back to diamond 615, discussed above.

If instead the next task is not to be performed on the same processor (e.g., core), control passes to block 660. There, the state is not maintained (block 660). Accordingly, control passes back to block 610 for obtaining a new task to be performed on the given processor core. While described with this particular implementation in the embodiment of FIG. 6, it is to be understood that the scope of the present invention is not so limited.

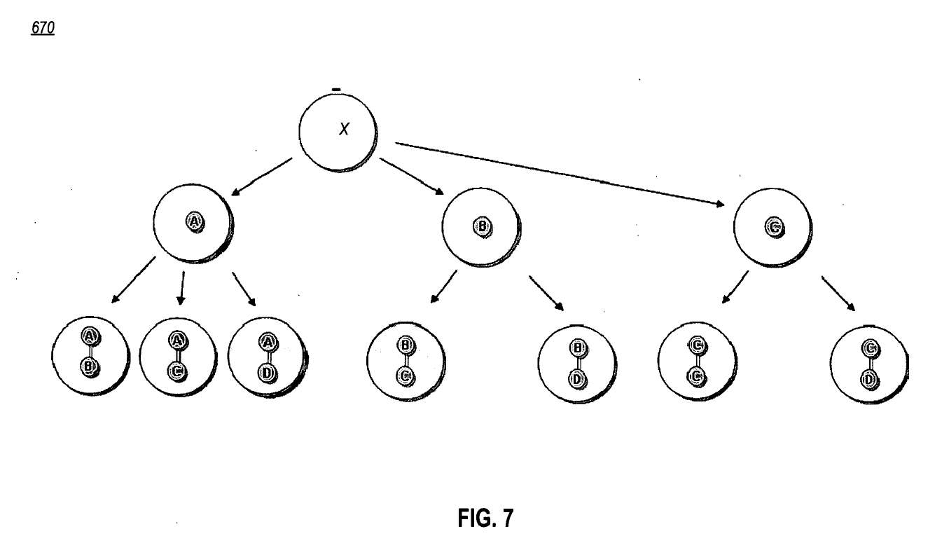

Referring now to FIG. 7, shown is an example of a search space for a depth-first graph mining algorithm in accordance with one embodiment. Each node in graph 670 is a potentially independent task. If the task is mined on the same processor (i.e, the shaded nodes in FIG. 7), the parent's state can be leveraged to improve cache performance and lower execution time. In addition, tasks can be partitioned to other cores (i.e., the white nodes in FIG. 7) to increase parallelism and to maintain load balance. Because these tasks would not make good use of cache locality and would increase the memory footprint if parent state is maintained, such state is not reused. Such reuse would also either create a dependency or complicate bookkeeping. For example, either the parent waits for the mining to occur before freeing the memory, or counters are implemented to determine when to free the memory.

Thus as shown in FIG. 7, graph 670 includes multiple levels of tasks to be performed in a depth-first manner. Accordingly, node X is mined into three different nodes, namely nodes A, B and C, each to be performed on a different processor. As further shown in FIG. 7, each of nodes A-C may further be mined into multiple subtasks. As shown in FIG. 7, node A may be mined into a first subnode A-B, a second subnode A-C and a third subnode A-D. Node B is mined into a first subnode B-C and a second subnode B-D. Node C is mined into a first subnode C-C and a second subnode C-D. Note that with regard to subnode A-D, it is to be performed on the same processor as node A. Accordingly, the state present in the processor executing node A may be saved for performance of subnode A-D. In contrast, the processors to perform subnodes A-B and A-C do not reuse the state, and accordingly, the state is not maintained or provided to the processors. With respect to node B, because subnode B-C is performed on the same processor as node B, the state is maintained for this subnode, while the state is not maintained for subnode B-D. As to node C, because neither of its subnodes is performed on the same processor, no state is saved for either of the subnodes.

Thus embodiments of an architecture-aware dynamic task partitioning scheme may be more efficient than static task partitioning. Task partitioning techniques in accordance with one embodiment may always maintain an optimal number of tasks regardless of system dynamics. In this way, an appropriate level of parallelism can be exploited without incurring significant parallelization overhead. Further, embodiments may adapt to different systems/environments better than static partitioning. That is, because on-the-fly feedback information is obtained from hardware, task scheduling may adapt to different systems or dynamic environments readily without human intervention. For example, if new processors are added, partitioning may automatically rebalance the parallelism to take advantage of the additional resources.

Cache-conscious task scheduling in accordance with an embodiment may use cache memory more efficiently because it leverages the knowledge of algorithmic data reuse and cache hardware architecture. For the same data set, a smaller working set may be maintained than a conventional algorithm. Thus a smaller cache may be used to achieve a desired level of performance, or a larger cache can handle a larger data set. Thus embodiments of the present invention may simultaneously implement good load balancing, good cache localities, and minimal communication overhead.

As mentioned above, embodiments are also suitable for computational financial algorithms. Portfolio optimization is the problem of finding the distribution of assets that maximizes the return on the portfolio while keeping risk at a reasonable level. The problem can be formulated as a linear or non-linear optimization problem. Such a problem is commonly solved using an interior-point method (IPM). The crux of IPM is a direct linear solver. Sparse direct solver computation is defined by an elimination tree (ET)—a task dependence graph which captures the order of updates performed on the rows of sparse matrix.

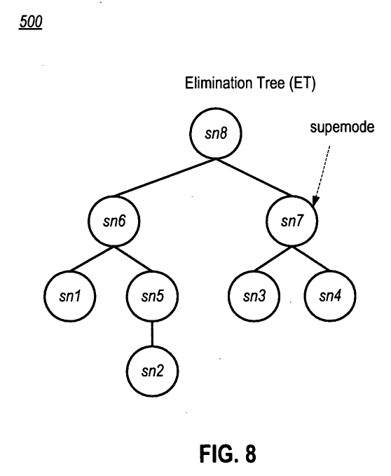

FIG. 8 describes the general structure of an ET and the computation flow common to three main modules in a direct solver: Cholesky factorization, backward and forward substitutions. As shown in FIG. 8, a tree structure 500 is present having multiple branches at different levels. More specifically, tree structure 500 includes supemodes (SN) 1-8. Parallelism exists both within the ET (each branch is independent) and each individual task (different pieces of data can be computed independently). However, the structure of the ET and the size of the tasks is data set dependent. Often, there exist many tasks at the bottom of the tree and very few tasks at the top. Under this situation, static task partitioning based on a fixed granularity would produce a suboptimal resource utilization (i.e., load imbalance). For example, if only coarse grain level parallelism is explored, there may be barely enough tasks at the bottom of the tree to keep all resources busy. Many resources will be idle at the top of the tree. Should one of these tasks be disproportionally large, the idle time for many resources will be long while waiting for this task to complete. If fine grain level parallelism is explored, often too many tasks are found at the bottom of the tree, which leads to very small task size and large overhead.

Using an embodiment of the present invention, a more efficient task partitioning is achieved. The process is as follows: during the early stage of the computation, tasks are partitioned based on coarse grain parallelism. When all coarse level tasks are dispatched, the application receives hardware feedback information. If there are still resources available, the application explores additional levels of parallelism to generate additional tasks to keep all resources busy. This process repeats and enables the application to explore deeper and deeper levels of parallelism as the computation moves towards the top of the ET (when not too many independent tasks remain).

When selecting a task to schedule on a processor, choosing a task that has more shared data with a “just completed” task reduces unnecessary cache misses and improves system performance. Such scheduling may be implemented via analysis of data usage ID's, in some embodiments. In the portfolio optimization scenario, this applies to schedule tasks from the same ET branch on the same processor. Since these tasks share much data, it would be best to schedule them on the same processor. Sometimes, however, when not enough tasks are available, these tasks can be scheduled on different processors. Under this circumstance, the scheduling algorithm may weight the benefit of parallel execution and cost of data contention and data migration.

Options are traded financial derivatives commonly used to hedge the risk associated with investing in other securities, and to take advantage of pricing anomalies in the market via arbitrage. There are many types of options. The most popular options are European options which can only be exercised at expiry, and American options which can be exercised any time up to the expiry. There are also Asian options whose payoff depends on time, and multi-asset options whose payoff depends on multiple assets. The key requirement for utilizing option is calculating their fair value.

A binomial tree (BT) is one of the most popular methods for option pricing today. It can be used to price single or multiple (two and three) assets options. A serial implementation of a BT algorithm including two nested loops is shown in Table 3.

TABLE 3

for (t=[expiry time of option], t>=[current time], t−−) {

for (j=0, j<[size of problem], j++) {

P[t][j] = P[t−1][j] + P[t−1][j+1];

}

}

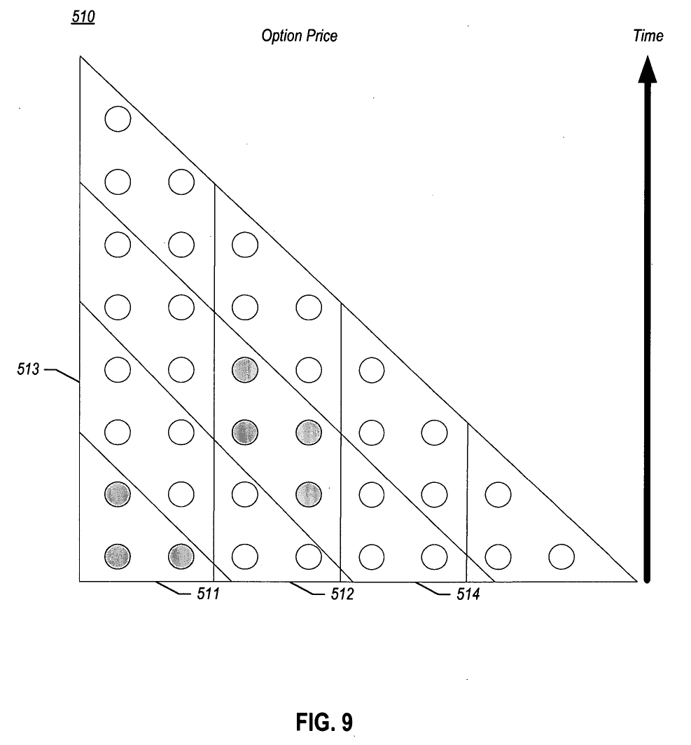

One partition would be to divide the problem in the time domain (i.e., the outer loop) and synchronize at the end of each time step. However, this simple partitioning suffers from too much synchronization overhead. Tile partitioning, as shown in FIG. 9 in connection with a tile diagram 510, may provide a more efficient partitioning. The tiles or blocks in tile diagram 510 are defined in the following manners: i) tiles from the same level are independent, such as tiles 511, 512 and 514 in FIG. 9, and can be computed in parallel; and ii) intra-tile computations are self-contained and only the inter-tile data communications are required across the tile boundary. For example, to compute boundary elements of block 513 will require data along the corresponding boundaries of blocks 511 and 512, in other words the top line of block 511 and the left line of block 512 in FIG. 9.

Similar to parallel task partitioning for frequent pattern mining and IPM direct solver, the binomial tree computational flow is affected by two fundamental partitioning issues. The first partitioning issue has to do with balance between amount of parallelism to explore and data locality. In the tile partitioning, the amount of parallelism available depends on the tile size. As the tile size reduces, the number of independent tiles increases; thus, the available parallelism increases. However, as the tile size reduces, the amount of computation and data reuse reduces. However, the task management overhead, such as boundary updates as well as task scheduling by the task scheduler increases. The second partitioning issue is related to the tree topology. As the computation advances (i.e., moving up the tree), fewer and fewer nodes are available. Eventually, there is only one node left. Since the amount of parallelism available is proportional to the number of independent nodes, parallelism reduces as computation advances.

A dynamic partitioning and locality-aware scheduling scheme may be applied to the binomial tree algorithm in the following way. At the beginning of the problem, a tile size is selected to provide adequate parallelism and good locality. As the computation advances, the amount of parallelism reduces. Occasionally, the application checks the status of available resources through architectural feedback mechanisms. Should the application find that resources are idle for an extended period of time, it can adjust the tile size to increase the number of parallel tasks. The frequency in which the application checks resource status affects the quality of load-balance. Frequent checking may results in a slightly more balanced execution, but will also lead to higher overhead. Thus a dedicated runtime balance checking system may obtain optimal performance.

When scheduling tasks on available resources, the same principle of favoring a task with more shared data from the “just finished” task still applies. Due to overhead incurred in moving data from one cache to another (due to contention or migration), random or systematic scheduling often leads to sub-optimal performance. Thus in scheduling tasks, the amount of data sharing by two tasks may be measured by a data sharing distance function, as described above.

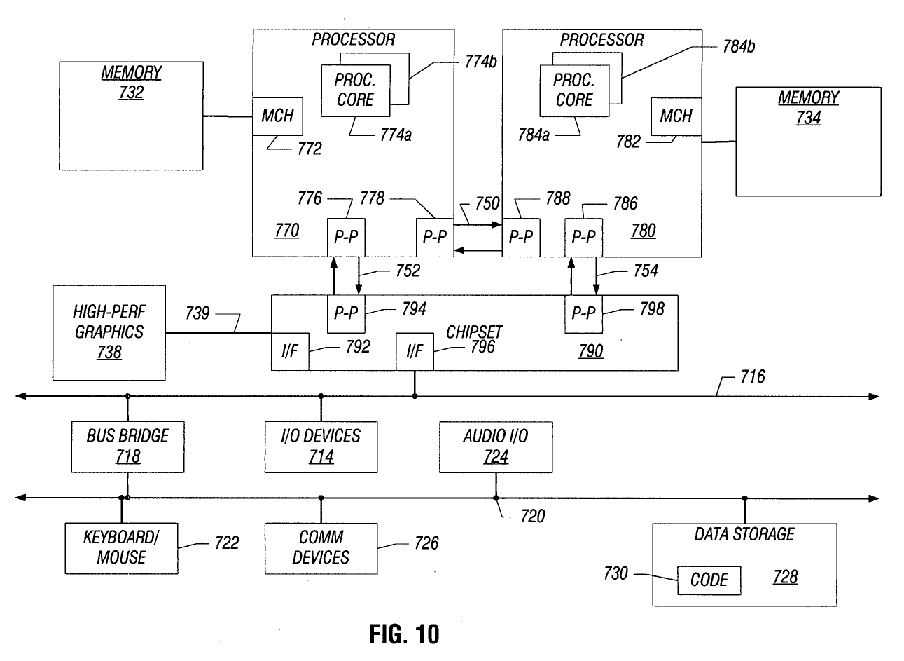

Embodiments may be implemented in many different system types. Referring now to FIG. 10, shown is a block diagram of a system in accordance with an embodiment of the present invention. As shown in FIG. 10, a point-to-point interconnect system includes a first processor 770 and a second processor 780 coupled via a point-to-point interconnect 750. As shown in FIG. 10, each of processors 770 and 780 may be multicore processors, including first and second processor cores (i.e., processor cores 774a and 774b and processor cores 784a and 784b). First processor 770 further includes a memory controller hub (MCH) 772 and point-to-point (P-P) interfaces 776 and 778. Similarly, second processor 780 includes a MCH 782 and P-P interfaces 786 and 788. While not shown in FIG. 10, it is to be understood that each core may have its own private cache, and each of first processor 770 and second processor 780 may have a shared cache for the cores therein. As shown in FIG. 10, MCH's 772 and 782 couple the processors to respective memories, namely a memory 732 and a memory 734, which may be portions of main memory locally attached to the respective processors.

First processor 770 and second processor 780 may be coupled to a chipset 790 via P-P interconnects 752 and 754, respectively. As shown in FIG. 10, chipset 790 includes P-P interfaces 794 and 798. Furthermore, chipset 790 includes an interface 792 to couple chipset 790 with a high performance graphics engine 738. In one embodiment, an Advanced Graphics Port (AGP) bus 739 may be used to couple graphics engine 738 to chipset 790. AGP bus 739 may conform to the Accelerated Graphics Port Interface Specification, Revision 2.0, published May 7, 1998, by Intel Corporation, Santa Clara, Calif. Alternately, a point-to-point interconnect 739 may couple these components.

In turn, chipset 790 may be coupled to a first bus 716 via an interface 796. In one embodiment, first bus 716 may be a Peripheral Component Interconnect (PCI) bus, as defined by the PCI Local Bus Specification, Production Version, Revision 2.1, dated Jun. 1995 or a bus such as the PCI Express bus or another third generation input/output (I/O) interconnect bus, although the scope of the present invention is not so limited.

As shown in FIG. 10, various I/O devices 714 may be coupled to first bus 716, along with a bus bridge 718 which couples first bus 716 to a second bus 720. In one embodiment, second bus 720 may be a low pin count (LPC) bus. Various devices may be coupled to second bus 720 including, for example, a keyboard/mouse 722, communication devices 726 and a data storage unit 728 which may include code 730, in one embodiment. Further, an audio I/O 724 may be coupled to second bus 720.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
performing a first level task of an application in a first processor of a system; and
dynamically scheduling a second level task of the application to one of the first processor and a second processor of the system based on architectural feedback information of the system.

2. The method of claim 1, further comprising dynamically scheduling the second level task of the application to the second processor based on presence of data for the second level task of the application in a cache of the second processor.

3. The method of claim 1, further comprising:
associating a first data usage identifier with the second level task of the application;
storing the second level task of the application as a first pending task, and the first data usage identifier, in a task queue; and
storing a second pending task of the second level of the application and a second data usage identifier in the task queue.

4. The method of claim 3, further comprising dynamically scheduling one of the first pending task and the second pending task to an available processor based on the first and second data usage identifiers and a history of tasks performed in the available processor.

5. The method of claim 3, further comprising:
determining a respective distance between an available processor and the first pending task and the second pending task based on the first data usage identifier and the second data usage identifier; and
dynamically scheduling the one of the first pending task and the second pending task associated with a smaller of the respective distances to the available processor.

6. The method of claim 1, further comprising dynamically scheduling the second level task based on processor availability information obtained from the architectural feedback information and cache locality information obtained from the application.

7. The method of claim 1, further comprising:
dynamically partitioning the second level task into at least a first subtask and a second subtask based on the architectural feedback information; and
dynamically scheduling the first subtask to the first processor and the second subtask to the second processor.

8. The method of claim 7, further comprising maintaining state of the first processor for the first subtask and not providing the state of the first processor to the second processor for the second subtask.

9. A system comprising:
a first processor;
a second processor coupled to the first processor; and
a scheduler to schedule tasks for execution on the first processor and the second processor, wherein the scheduler comprises:
a task partitioner to dynamically partition one or more pending tasks of an application based on architectural feedback information from the first processor and the second processor; and
a resource scheduler to schedule the one or more pending tasks to an available resource of the first processor or the second processor based on application feedback information from the application.

10. The system of claim 9, further comprising a task queue to store the one or more pending tasks of the application.

11. The system of claim 10, wherein the task queue is to further store a data locality identifier with each of the one or more pending tasks.

12. The system of claim 11, wherein the scheduler is to assign one of the pending tasks to the first processor based on the data locality identifier stored with the pending task and a history of data locality identifiers associated with tasks executed by the first processor.

13. The system of claim 9, further comprising:
a third processor and a fourth processor having a first shared cache memory; and
a second shared cache memory coupled to the first processor and the second processor, wherein the first processor includes a first private cache and second processor includes a second private cache.

14. The system of claim 13, wherein the scheduler is to schedule a pending task to the first processor if data therefor is in the first private cache or the second shared cache, otherwise the scheduler is to schedule the pending task to the third processor or the fourth processor.

15. The system of claim 9, wherein the scheduler is to determine whether the first processor is to maintain prior state information upon execution of a current one of the one or more pending tasks on the first processor.

16. The system of claim 9, wherein the task partitioner is to dynamically partition a pending task into a plurality of pending tasks if at least one of the first processor and the second processor is about to idle.

17. An article comprising a machine-readable medium including instructions that when executed cause a system to:
execute a parent task of an application on a first processor; and
dynamically partition the parent task into descendent tasks including at least a first descendent task and a second descendent task based on architectural feedback information of the system.

18. The article of claim 17, further comprising instructions that when executed cause the system to maintain state information associated with the first processor if any of the descendent tasks are to be executed on the first processor, otherwise discard the state information.

19. The article of claim 17, further comprising instructions that when executed cause the system to determine whether to maintain state information at a runtime of the application.

20. The article of claim 17, further comprising instructions that when executed cause the system to dynamically schedule the first descendent task to the first processor based on application feedback information from the application.

21. A method comprising:
partitioning a first task into at least a first subtask and a second subtask;
scheduling the first subtask to a first processor of a system and the second subtask to a second processor of the system; and
maintaining state of the first processor for the first subtask and not providing the state of the first processor to the second processor for the second subtask.

22. The method of claim 21, wherein scheduling the first subtask comprises determining whether data to be used by the first subtask is closer to the first processor than the second processor.

23. The method of claim 22, wherein determining whether the data is closer to the first processor comprises comparing a first data distance between the first processor and the data based on a history of tasks executed on the first processor and a second data distance between the second processor and the data based on a history of tasks executed on the second processor.

24. The method of claim 21, further comprising:
scheduling the second subtask to the second processor based on application feedback information; and
creating a new state in the second processor for executing the second subtask without communication of the state of the first processor.

25. The method of claim 21, further comprising partitioning tasks of an application including the first task according to a first grain level at an early stage of the application and according to a second grain level at a later stage of the application, wherein the first grain level is coarser than the second grain level.

26. The method of claim 21, further comprising scheduling the first subtask to the first processor and the second subtask to the second processor based on application feedback information.

27. The method of claim 21, further comprising dynamically partitioning the first task based on architectural feedback information of the system.
